(19) United States
(12) Patent Application Publication
(10) Pub. No.: US 2008/0266087 A1
(43) Pub. Date: Oct. 30, 2008

(54) Optical Security Sensors, Systems, and Methods

(76) Inventors: Robert C. Tatar, Saratoga Springs, NY (US); Kevin R. Stewart, Latham, NY (US)

Correspondence Address: HESLIN ROTHENBERG FARLEY & MESITI PC, 5 COLUMBIA CIRCLE, ALBANY, NY, 12203, US

(21) Appl. No.: 11/815,833

(22) PCT Filed: Feb. 8, 2006
(86) PCT No.: PCT/US2006/004454

§ 371 Date: May 1, 2008

Related U.S. Application Data
(60) Provisional application No. 60/651,191, filed on Feb. 9, 2005.

(51) Int. Cl. G08B 13/18

(52) U.S. Cl. 340/555

(57) ABSTRACT

A security system includes an optical fiber, a plurality of sensors, and a light source, detector, and a controller. The optical fiber and sensors are attached and positioned along a fence. The optical fiber passes through the sensors. The sensors include a hinged striker having a weight that swings under the influence of gravity and is movable in response to vibration of the fence to compress and bend the optical fiber and attenuate transmission of an optical signal through the optical fiber. In another embodiment, an optical fiber cable having a plurality of optical fibers may be employed to define zones and allow determination of intrusion of a particular portion of the fence. In a further embodiment, a ground sensor is disclosed.

### CROSS-REFERENCE TO RELATED APPLICATION

This application claims the benefit of U.S. Provisional Application No. 60/651,191, filed Feb. 9, 2005, entitled “Fiber Optic Fence Security Sensor and System,” the entire subject matter of these applications being incorporated herein by reference.

### FIELD OF THE INVENTION

The present invention relates to security systems and, more specifically, to optical security sensors, systems, and methods.

### BACKGROUND OF THE INVENTION

With the greater awareness of security threats, there is an increasing need for security systems that sense potential intrusions, analyze the sensor signals to evaluate the likelihood of attack, and communicate with a centralized security system. Perimeter fencing offers protection by being a barrier to intrusion.

Historically fence security systems have been comprised of taut wires connected to sensors that detect changes in tension. These systems typically have thresholds that the tension sensors need to exceed before a signal is generated. In order to avoid the nuisance of false alarms these threshold may have to be set so that actual attacks may be neglected.

Another technology used for fence security is a fiber optic cable used as an intrinsic sensor. Fiber optic cable, particularly multimode fiber, is sensitive to motion and can sense cutting or climbing on a fence. A disadvantage of these systems is that they are very sensitive to noise, especially wind, and false alarms are problematic. Additionally, since multimode fibers will only transmit light over relatively short distances, this demands placing the system electronics near the perimeter fence.

Still another technology used for perimeter security is free-space optical beam networks. These systems have lasers and detectors mounted on tripods and can detect the presence of intruders as they break the invisible light beams. A disadvantage of these systems is that the sensitive alignment of transmitters, receivers, and reflectors can be compromised by wind and ground vibrations or by the wear of fixtures under the constant force of the earth's gravity.

There is a need for further optical security sensors, systems, and methods.

### SUMMARY OF THE INVENTION

The present invention provides in a first aspect, a sensor for use with at least one optical fiber for a fence security system. The sensor includes a plate for attaching the sensor to the fence, a striker movably attached to the plate and the striker comprising a weight. The sensor is configured for receiving the at least one optical fiber between the striker and the plate. The striker is movable in response to vibration of the fence towards and away from the plate to compress the at least one optical fiber between the striker and the plate to bend the at least one optical fiber and attenuate transmission of an optical signal through the at least one optical fiber.

The present invention provides in a second aspect, a security system for a fence. The system includes at least one optical fiber positionable along a portion of the fence, at least one sensor as described above positionable on the fence for receiving a portion of the at least one optical fiber and attenuating and optical signal through the at least one optical fiber, and a monitoring unit positionable remotely from the at least one sensor. The monitoring unit includes a light source for transmitting the optical signal into an end of the at least one optical fiber, a detector for detecting the optical signal from the other end of the at least one optical fiber, and a controller operably connected to the light source for controlling transmission of the optical signal and operably connected to the detector for detecting attenuation of the optical and generating a warning based the detected attenuated optical signal.

The present invention provides in a third aspect, a security system for a fence. The security system includes an optical fiber cable positioned along a portion of the fence and in which the optical fiber cable includes a plurality of optical fibers, at least one sensor attached to a different portion of the fence for receiving a portion of a different one of the plurality of optical fibers to define a plurality of zones, the sensor operable to attenuate transmission of an optical signal through the optical fiber in response vibration of the fence, and a monitoring unit positioned remotely from the plurality of sensors and the fence so that the plurality of optical fibers is positioned in a loop connected to the monitoring unit. The monitoring unit includes a light source for transmitting an optical signal into a plurality of ends of the plurality of optical fibers, a detector for detecting the optical signal from the other end of the plurality of optical fibers, and a controller operably connected to the light source for controlling transmission of the optical signal and operably connected to the detector for detecting attenuation of the optical signal and generating a warning based the detected attenuated optical signal.

The present invention provides in a fourth aspect, a method for monitoring a fence. The method includes transmitting an optical signal through a first end of an optical fiber positioned on the fence, compressing the optical fiber between a plate attached to the fence and a striker having a weight which is movable under the influence of gravity towards and away from the optical fiber in response to vibrations of the fence to bend the optical fiber and attenuate transmission of the optical signal through the optical fiber, detecting the attenuated optical signal at the other end of the optical fiber, and generating a warning based the detected attenuated optical signal.

The present invention provides in a fifth aspect, a method for monitoring a fence. The method includes transmitting a plurality of optical signals through a first end of a plurality of optical fibers positioned along the fence and in which at least one sensor is attached to a different portion of the fence for receiving a portion of a different one of the plurality of optical fibers to define a plurality of zones, the sensors operable to compress the optical fibers to bend the optical fiber and attenuate transmission of an optical signal through the optical fiber in response vibration of the fence, detecting at least one attenuated optical signal at the other ends of the plurality of optical fibers, and generating a warning based on attenuation of the optical signal.

The present invention provides in a sixth aspect, a security system for detecting intrusion. The security system includes a support positionable on the ground having a length and width and comprising a plurality of apertures extending therethrough, at least one optical fiber extending along the length and width of the support, and a monitoring unit positioned remotely from the support. The monitoring unit includes a light source for transmitting an optical signal into an end of the at least one optical fiber, a detector for detecting the optical signal from the other end of the plurality of optical fibers, and a controller operably connected to the light source for controlling transmission of the optical signal and operably connected to the detector for detecting attenuation of the optical and generating a warning in based on the detected attenuated optical signal.

The present invention provides in a seventh aspect, a method for monitoring an area for intrusion. The method includes providing an optical fiber extending along a width and a length of a horizontally disposed planar support having a plurality of apertures extending therethrough, positioning the optical fiber and the support on the ground, transmitting an optical signal through a first end of the optical fiber, compressing the optical fiber between a force and a portion of the support adjacent to the apertures to bend the optical fiber and attenuate transmission of the optical signal through the optical fiber, detecting the attenuated optical signal at the other end of the optical fiber, and generating a warning of intrusion of the area based the detected attenuated optical signal.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and accompanying drawings in which:

FIG. 1 is diagrammatic illustration of an optical fence security system in accordance with the present invention;

FIG. 2 is a perspective view of one of the plurality of sensors of the optical fence security system of FIG. 1;

FIG. 3 is a perspective view of the sensor of FIG. 2;

FIG. 4 is a block diagram of the monitoring unit of FIG. 1;

FIG. 5 is a graph of the amplitude over time for signals from sensors numbered 12 to 30 installed on fence;

FIG. 6 is diagrammatic illustration of another embodiment of an optical fence security system in accordance with the present invention employing an optical fiber cable;

FIG. 7 is a perspective view of one of the plurality of sensors of the optical fence security system of FIG. 6;

FIG. 8 is a block diagram of the monitoring unit of FIG. 6;

FIG. 9 is diagrammatic illustration of another embodiment of an optical fence security system in accordance with the present invention employing an optical fiber cable and a plurality of sensor per zone;

FIG. 10 is a diagrammatic illustration of another embodiment of a fence security system in accordance with the present invention;

FIG. 11 is a block diagram of the monitoring unit of FIG. 10; and

FIG. 12 is diagrammatic illustration of another embodiment of an optical security system in accordance with the present invention for use as a ground sensor.

### DETAILED DESCRIPTION OF THE INVENTION

The present invention is directed to improving the security of perimeter fences by monitoring fence vibrations using a series of fiber optic sensors installed on the fence and/or monitoring motion via ground sensors positioned on the ground, and optoelectronic circuitry that may interface with other security systems. The sensors for the fence may employ a striker having a weight which swings under the influence of gravity and which is movable in response to vibration of the fence to compress and/or bend an optical fiber to attenuate transmission of an optical signal (cause optical loss) through the optical fiber. In one embodiment, the sensors may be installed on the perimeter fence and monitored using a single optical fiber. In another embodiment, the sensors may be installed on the perimeter fence and monitored via an optical fiber cable having a plurality of optical fibers, thereby enabling the sensors to be collected into zones for detection of the alarm position. A further embodiment includes a ground sensor. As will become apparent from the description below, the various systems result in a security system where the electronic control may be positions away from the fence or sensor, and where no electrical power is required along the fence or sensor. In addition, by configuring the optical fiber or optical fiber cable in a loop, the positioning of the optoelectronic circuitry (e.g., a light source, a detector, and a controller) may be in the same location.

Desirably, the optical fiber of the present invention for the fence sensor uses a single-mode fiber for carrying a single electromagnetic wave and which has a generally smaller diameter and allows for generally longer transmission distances and lower attenuation compared to multimode fibers. With use of a single-mode fiber, the fence systems of the present inventor may employ a single optical fiber or an optical fiber cable having a plurality of optical fibers that has a length of tens of kilometers, and up to 100 kilometers.

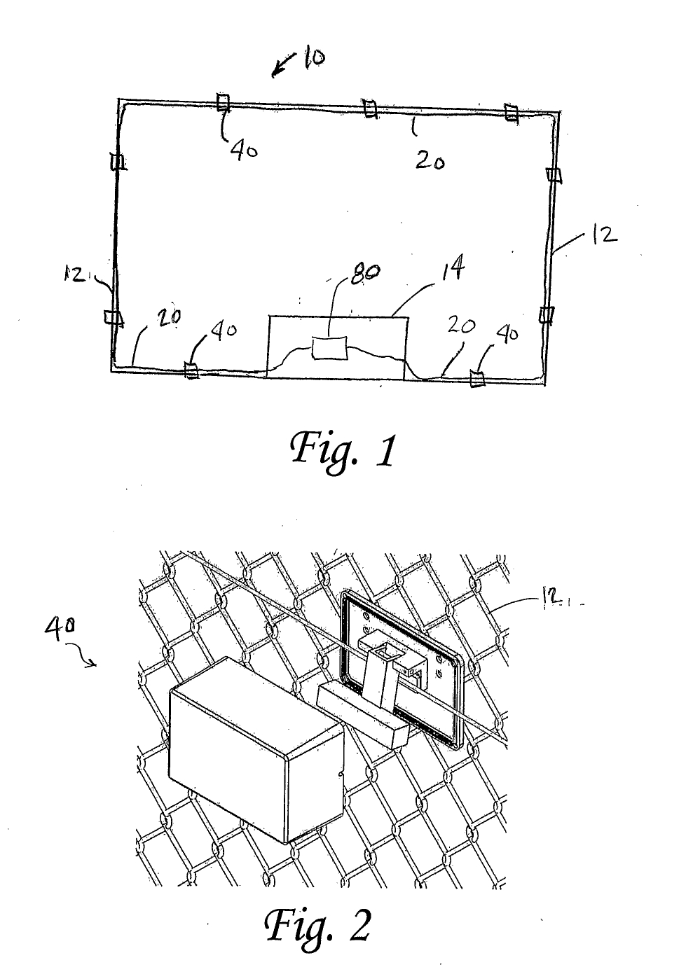

FIG. 1 illustrates a first embodiment of a fence security system 10 in accordance with the present invention. For example, fence security system 10 may include an optical fiber 20, a plurality of sensors 40, and a monitoring unit 80. Optical fiber 20 may be suitably attached and positioned along a security fence 12 surrounding a building 14. Optical fiber 20 forms a loop with the ends of the optical fiber operably connected to monitoring unit 80 which may be securely disposed in building 14. Optical fiber 20 passes through sensors 40, one of which is shown in FIG. 2. Sensors 40 are suitably attached to fence 12. For example, the fence may be a chainlink fence made of thick steel wire interwoven in a diamond pattern.

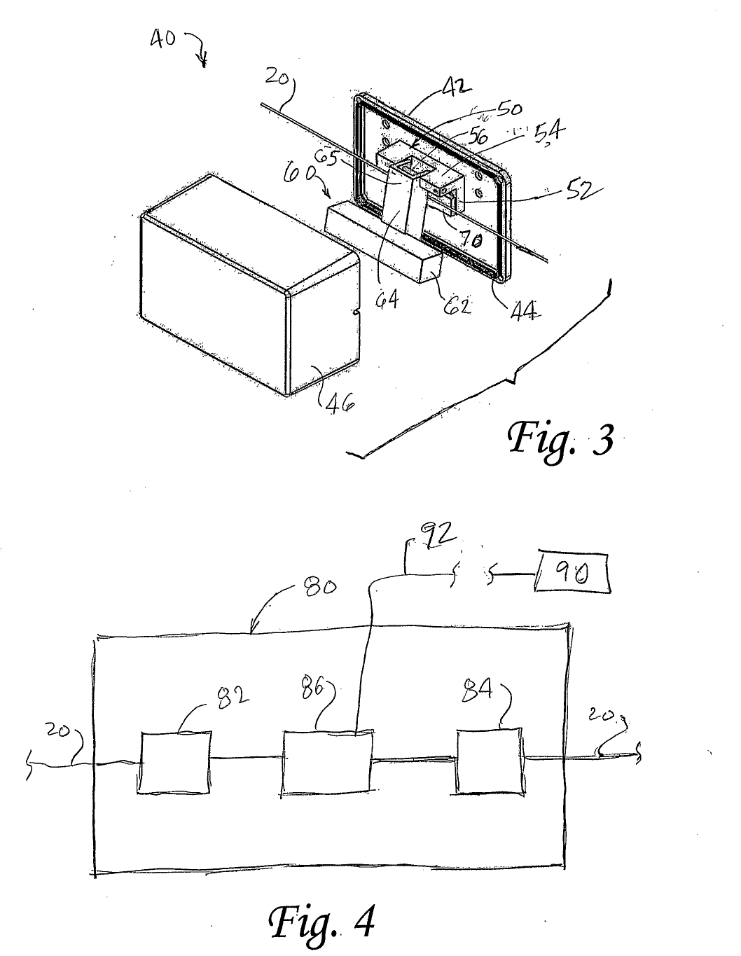

As best shown in FIG. 3, sensor 40 generally includes a mounting plate 42, a hinge support 50, a hinged striker 60 having a weight 62, a rubber pad 70, a gasket 44, and a cover 46. Mounting plate 42 may include one or more holes for attaching a rear surface of mounting plate 42 to the interwoven wires of the fence. Cover 46 is attached to the outer peripheral edge of mounting plate to seal the interior of the sensor from the elements such as rain and snow. Cover 46 and mounting plate 42 may be snap-fit together, attached using screws or bolts, sealed together by welding or an adhesive, or attached using other suitable means. Gasket 44 may be disposed around the peripheral edge of the mounting plate to form a watertight seal between the mounting plate and the cover.

Hinge support 50 may be an L-shaped bracket having a vertical leg 52 attached to mounting plate 42 and a horizontal leg 54 having a cutout for receiving and supporting an upper end 65 of hinged striker 60 via a pin 56. Rubber pad 70 is attached to the vertical leg of the hinge support. The hinged striker may have a C-channel configuration having a web and two legs. As described below, an optical fiber may be positioned between the upper portion of hinged striker 60 and rubber pad 70. The edges of legs of the hinged striker contact the optical fiber at two points. It will be appreciated that other configurations of the hinged striker may be employed, for example, a solid striker having a single pointed or rounded edge for engaging the optical fiber.

The hinged striker may be formed from, but not limited to, aluminum, steel, or plastic and may have elastomeric inserts at the optical fiber contact area. The weight may be formed from, but not limited to, steel, lead, aluminum, or plastic. The rubber pad may be made from a material which is soft and resilient, such as an elastomeric material. Exemplary materials for the rubber pad include, but are not limited to, silicone, ethylene propylene terpolymer rubber (EPDM), polyurethane, and butyl rubber, which is a copolymer of isobutylene and isoprene.

The mounting plate and the cover may be made from, but not limited to, materials such as plastic, aluminum, or steel. As used herein, the term “plastic” refers to thermoplastics and thermosets, and composites thereof, such as polyethylene, polyacrylate, polypropylene, polystyrene, polysulfone, polyetheretherketone (PEEK), polycarbonate, polyvinylchloride, and the like.

In a typical installation, the mounting plate with attached striker mechanism is fixed to the fence by cable ties, screw, bolts, clips, or other suitable holding means. An optical fiber such a SMF28 from Corning may be fixed to the rubber pad using tape or by mechanical means. The striker contacts the buffer surrounding the optical fiber (either 900 micron or 3 mm buffer) upon vibration of the fence. With use of the C-channel shaped striker, the optical fiber will be contacted at two points. The contact area may be about 0.02-0.15 inches.

When the fence is hit or climbed upon, the resulting vibrations cause the weight to swing towards and away from the optical fiber. As the weight swings toward and contacts the optical fiber, the optical fiber is compressed between the striker and the rubber support, the contact points of the striker cause small bends in the optical fiber and these in turn cause attenuation (e.g., a reduction in the strength) of the light intensity propagating through the optical fiber. It will be appreciated that the weight aids in the compression of the optical fiber and the sensitivity of the attenuation of the optical signal through the optical fiber compared to the striker not having a weight.

With reference again to FIG. 1, the optical fiber is operably connected to monitoring unit 80. As best shown in FIG. 4, one end of optical fiber 20 is operably connected to light source 82 such as a laser light source or light-emitting diode (LED). The other end of optical fiber 20 is operably connected to detector 84 such as a photodetector. Controller 86 is operably connected to both light source 82 and detector 84. The controller may include a processor or circuitry for controlling the light source, the detector, and communicating with a central monitoring system 90 as described below.

For example, controller 86 may control the intensity and/or wavelength of the light output from light source 82, and convert the detected light intensity from detector 84 into a time-varying, proportional electrical voltage. Controller 86 may also attenuate or amplify the voltage to achieve a voltage magnitude that is convenient for further processing.

The voltage is then processed by an analog or digital filter to both suppress undesired signal characteristics and to enhance desired signal characteristics. The magnitude of the resulting signal is compared to an adjustable, preset threshold. When the magnitude exceeds the threshold, the circuitry signals an alarm condition to a central monitoring system via a wire 90 or remotely via, for example, a transmitter. Various other parameters can also be transmitted to the central monitoring system, including an identifier and location of the sensor, a signal magnitude, a time signature, and a sample of the signal magnitude just prior to and just following the threshold crossing.

A system including zones defined as a group of 30 sensors mounted on a 300-foot span of a chainlink security fence was tested. Each sensor was mounted on a separate 10-foot section of the fence. A single-mode optical fiber (SMF-28) with a UV-resistant 900-micron jacket was passed through each sensor. One end of the optical fiber was attached to a laser diode with a peak intensity near 1550 nanometers and up to 0.8 milliwatt of output power. The intensity of the light launched into the optical fiber was adjusted by controlling an electrical current passing through the laser diode. The current was adjusted to provide approximately 0.25 milliwatt of light. The other end of the optical fiber was attached to an InGaAs PIN photodetector in series with a 10K ohm resistor to convert the light intensity into a proportional voltage. The voltage signal was connected to the input of a first-order, high-pass filter with a cutoff-frequency of 15 Hertz. This filter was intended to reject low-frequency disturbances such as those that might be caused by the wind. The output of the high-pass filter was passed through a half-wave rectifier to provide an amplitude detector. The amplitude detector was followed by a low-pass filter with a 1,500 Hertz cutoff frequency. This combination allowed the rejection of nuisance signals. The signal was then passed to a threshold detector with a settable threshold. The output of the threshold detector was passed to a monostable multivibrator with a settable timeout. In the experiment, a timeout of 1 second was selected. The timer signal was passed to a visual indicator. In addition, because the signals are in the audible frequency range, the signal was passed to an amplifier and speaker.

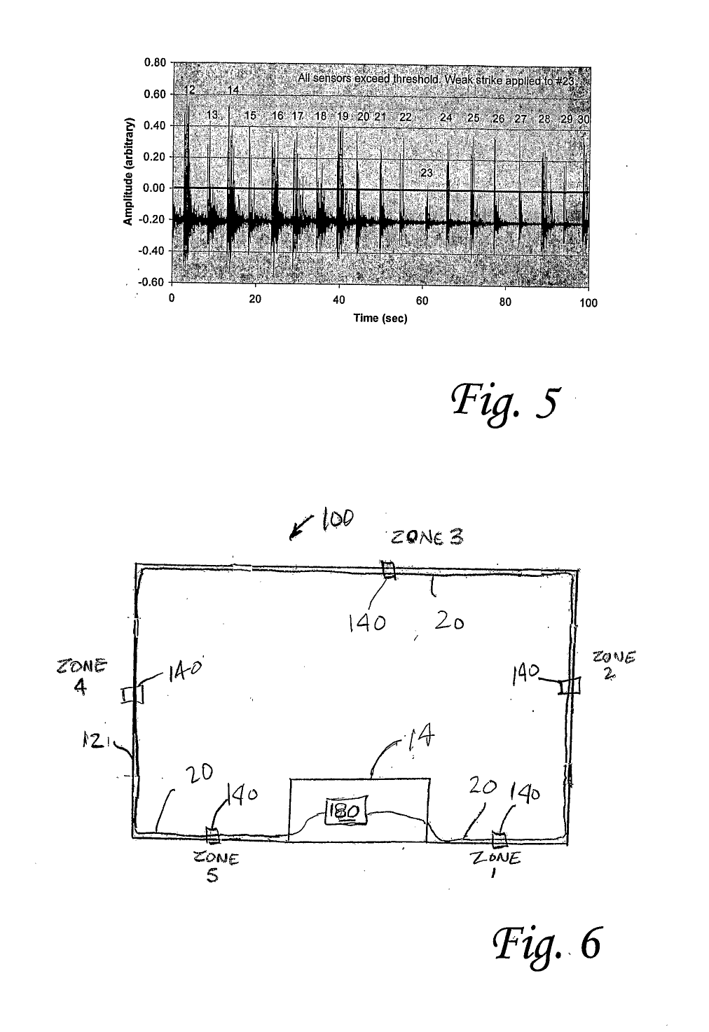

The loss through a sensor in its resting position is a fraction of 1 decibel (dB), typically less than 0.2 dB. With such low loss, it is feasible to connect many sensors in series. FIG. 5 illustrates the signals from sensor number 12 through 30 from the test powered by a sub-milliwatt laser light source.

FIG. 6 is diagrammatic illustration of another embodiment of a fence security system 100 in accordance with the present invention employing an optical fiber cable having a plurality of optical fibers. For example, fence security system 100 includes an optical fiber cable 120, a plurality of sensors 140, and a monitoring unit 180. Optical fiber cable 120 may be suitably attached and positioned along a security fence 12 surrounding a building 14. Optical fiber cable 120 forms a loop with the ends of the plurality of optical fibers operably connected to monitoring unit 180 which may be securely disposed in building 14.

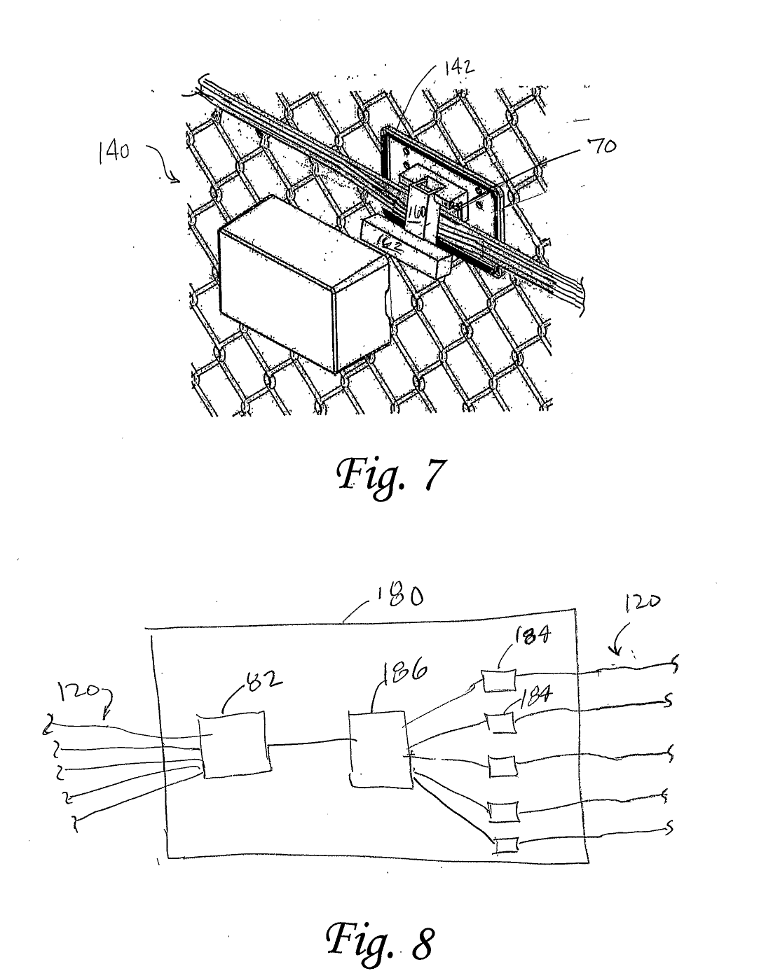

The optical fiber cable 120 passes through each of sensors 140 attached to fence 12, one the sensors of which is shown in FIG. 7. For example, fence 12 may be a chainlink fence made of thick steel wire interwoven in a diamond pattern. Sensor 140 is essentially the same as sensor 40 of FIGS. 2 and 3 and described above with the exception that only one of the optical fibers is positioned on rubber pad 70 for engagement with striker 60. The other optical fibers are positioned away from the rubber pad and from contact with the striker.

With reference again to FIG. 8, the controller 180 may be operated to monitor each of the optical fibers of the optical fiber cable using a separate detector 84 for each optical fiber. Alternatively, a single detector may be used and employed with a multiplexer to sequentially and periodically monitor each of the optical fibers of the optical fiber cable.

Further, by using an optical fiber cable, different zones can be created over the distance covered by the optical fiber cable when attached to a fence. The monitoring unit may be configured to determine the location (zone) of possible intrusion and sound an alarm that indicates that particular zone. The optical fiber cable approach allows the creation of zones for monitoring different sensor positions, without the need to run additional connections to each different zone.

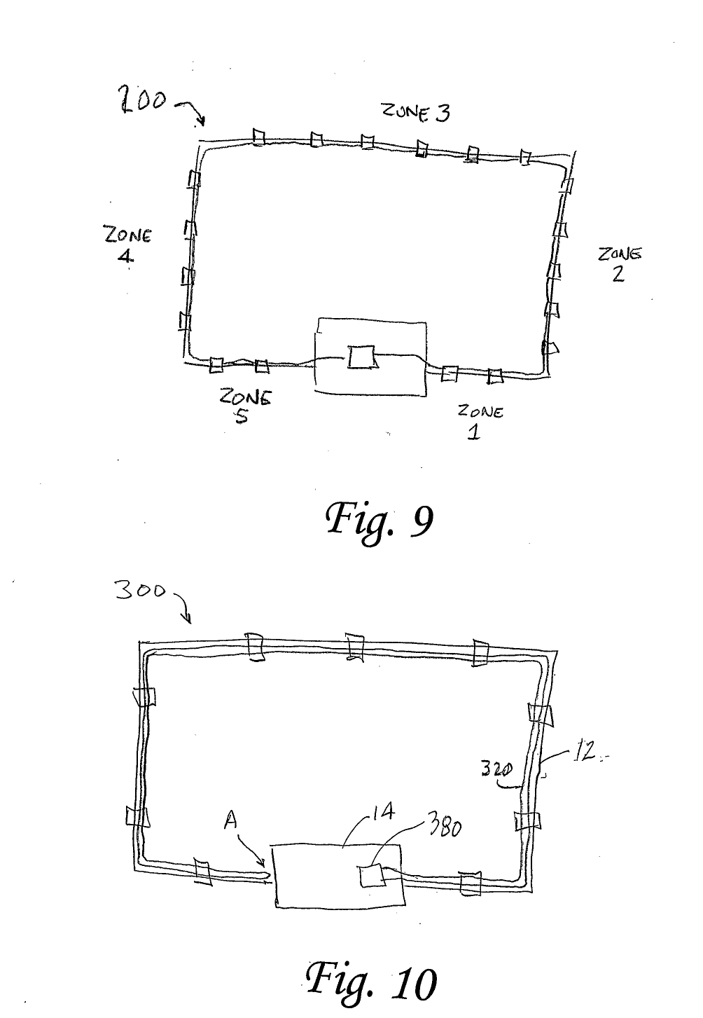

With reference to FIG. 9, multiple groups of sensors may be incorporated into each zone to allow coverage of a greater span or length of the fence. For example, a security system 200 is essentially the same as security system 100 with the exception that each group of sensors may include 30 to 50 sensors and span 300 feet to 500 feet of fence. The controller may be designed so that each group is controlled by a replaceable module or card that shares a common interface in a rack-mounted assembly.

In the various embodiments, the optical fiber or optical fiber cable can be installed loosely along the length of the fence and need not be taut or tightly drawn along the fence. The controller may also be operable provide an active monitoring for detection of any breaks in the security loop. The light source, detector and controller can also be shielded from electromagnetic assault in a secure building. While a side of the fence illustrated in FIG. 9 is defined by a zone, it will be appreciated that a side of a fence may be broken into two or more zones.

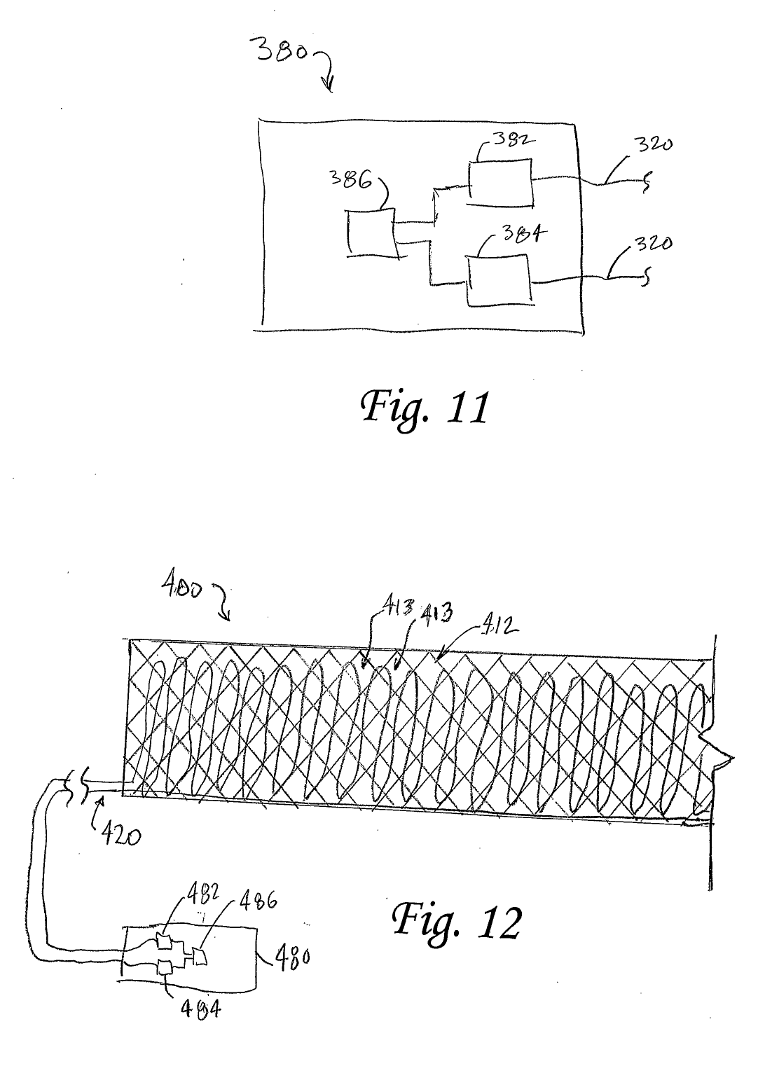

FIG. 10 illustrates another embodiment of a fence security system 300 in accordance with the present invention. Security system 300 employs a single optical fiber 320 in a loop along the length of the perimeter of a fence 12, i.e., the optical fiber is looped, at point A, back along itself. A monitoring unit 380, which as shown in FIG. 11, includes a light source 382, a detector 384, and a controller 386. In a similar manner, another embodiment of a fence security system may employ an optical fiber cable having, e.g., 256 optical fibers, which may be disposed along the perimeter of the fence. Instead of the optical fiber cable being looped back on itself (for example, at point A in FIG. 10), the ends of half of the optical fibers of the optical fiber cable, e.g. the ends of 128 optical fibers, may be optically spliced to the ends of the other 128 optical.

FIG. 12 illustrates an embodiment of a security system 400 in accordance with the present invention for use, for example, as a ground sensor to detect a change in motion of an intruder. Security system 400 may generally include a horizontally disposed planar support 412, an optical fiber 420, and a monitoring unit 480. Support 412 includes a plurality of apertures 413 extending therethrough defining a surface, and may, for example, be a plastic or wire mesh. Optical fiber 420 is positioned on the surface and extends along a width and a length of support 412. Support 412 and optical fiber 420 may be disposed on or under the ground, for example, surrounding a fence (not shown). Desirably, the security sensor 400 is buried under the surface of the ground and covered with material, e.g., soil or sand, to blend with the surrounding ground cover. In addition, the security system may be placed on a floor covered with carpet for an indoor application. Depending on the application, either a multimode fiber or a single mode fiber may be employed in the ground sensor.

When an intruder steps on security system 400, the foot of the intruder applies a force to the optical fiber to cause small bends in the optical fiber, for example, around the plastic or wire portions of the wire mesh, and these in turn cause attenuation (e.g., a reduction in the strength) of the light intensity propagating through the optical fiber. Monitoring unit 480 is essentially the same as monitoring unit 80 shown in FIG. 4 and described above which may be suitably employed for monitoring for an intruder.

In another embodiment, a ground sensor may be employed employing a plurality of optical fibers. For example, a different optical fiber may be used to cover a portion of the support thereby creating zones as described above in connection with the fence security sensor.

The present invention may also include a combination fence security system and ground security sensor as described above. For example, one or more ground security sensors may be spaced around a perimeter of a fence to provide an additional means for detection of an intruder.

The present invention is useful for many types of security applications, such as homeland security, power plant and refinery installations, military fixed and mobile applications, and electric substation monitoring applications. In most applications the security system will be one part of an integrated security system. In addition, a ground sensor may be positioned on a boat or yacht which is moored at a dock to detect intruders. In these cases the electronic interface will supply alarm signals, contact closures, or other signals depending on the protocols incorporated in the integrated security system.

While various embodiments of the present invention have been illustrated and described, it will be appreciated by those skilled in the art that many further changes and modifications may be made thereunto without departing from the spirit and scope of the invention.

1. A sensor attachable to a fence for use with at least one optical fiber for a fence security system, said sensor comprising:
a plate for attaching said sensor to the fence;
a striker movably attached to said plate and said striker comprising a weight, said sensor configured for receiving the at least one optical fiber between said striker and said plate; and
wherein said striker is movable in response to vibration of the fence towards and away from said plate to compress the at least one optical fiber between said striker and said plate to bend the at least one optical fiber and attenuate transmission of an optical signal through the at least one optical fiber.

2. The sensor of claim 1 wherein said striker swings under the influence of gravity.

3. The sensor of claim 1 wherein said striker is pivotally attached to said plate.

4. The sensor of claim 3 wherein said striker comprises a C-channel for providing two spaced-apart surfaces for compressing and bending the optical fiber between said striker and said plate.

5. The sensor of claim 3 further comprising a support attached to said plate for pivotally supporting said striker and fixedly supporting the at least one optical fiber.

6. The sensor of claim 5 wherein said support comprises an L-shaped bracket having a vertical leg attached to said plate and a horizontal leg having a cutout for receiving and supporting an upper end of said striker via a pin.

7. A security system for a fence, the security system comprising:
at least one optical fiber positionable along a portion of the fence;
at least one sensor of claim 1 positionable on the fence for receiving a portion of the at least one optical fiber and attenuating an optical signal through the at least one optical fiber; and
a monitoring unit positionable remotely from said at least one sensor, said monitoring unit comprising:
a light source for transmitting an optical signal into an end of said at least one optical fiber;
a detector for detecting the optical signal from the other end of said at least one optical fiber; and
a controller operably connected to said light source for controlling transmission of the optical signal and operably connected to said detector for detecting attenuation of the optical and generating a warning based on the detected attenuated optical signal.

8. The security system of claim 7 wherein said at least one sensor comprises a plurality of said sensors positionable at different locations on the fence.

9. The security system of claim 7 wherein said monitoring unit is securely positioned in a building.

10. A security system for a fence, the security system comprising:
an optical fiber cable positioned along a portion of the fence, said optical fiber cable comprising a plurality of optical fibers;
at least one sensor attached to a different portion of the fence for receiving a portion of a different one of said plurality of optical fibers to define a plurality of zones, said sensor operable to attenuate transmission of an optical signal through said optical fiber in response vibration of the fence; and
a monitoring unit positioned remotely from said plurality of sensors and said fence so that said plurality of optical fibers is positioned in a loop connected to said monitoring unit, said monitoring unit comprising:
a light source for transmitting an optical signal into a plurality of ends of said plurality of optical fibers;
a detector for detecting the optical signal from the other end of said plurality of optical fibers; and
a controller operably connected to said light source for controlling transmission of the optical signal and operably connected to said detector for detecting attenuation of the optical signal and generating a warning based on the detected attenuated optical signal.

11. The security system of claim 10 wherein said monitoring unit is securely positioned in a building.

12. The security system of claim 10 where in said detector comprises a plurality of detectors, each detector for detecting the optical signal from a different one of said plurality of optical fibers.

13. The security system of claim 10 wherein said at least one sensor attached to a different portion of the fence for receiving a portion of a different one of said plurality of optical fibers to define a plurality of zones comprises a plurality of sensors attached to a different portion of the fence for receiving a portion of a different one of said plurality of optical fibers to define the plurality of zones.

14. The security system of claim 10 wherein said sensors comprise:
a plate for attaching said sensor to the fence;
a striker movably attached to said plate and said striker comprising a weight, said sensor configured for receiving a different one of said plurality of optical fibers between said striker and said plate; and
wherein said striker is movable in response to vibration of the fence towards and away from said plate to compress the at least one optical fiber between said striker and said plate to bend the at least one optical fiber and attenuate transmission of an optical signal through the at least one optical fiber.

15. A method for monitoring a fence, the method comprising:
transmitting an optical signal through a first end of an optical fiber positioned on the fence;
compressing the optical fiber between a plate attached to the fence and a striker having a weight which is movable under the influence of gravity towards and away from the optical fiber in response to vibrations of the fence to bend the optical fiber and attenuate transmission of the optical signal through the optical fiber;
detecting the attenuated optical signal at the other end of the optical fiber; and
generating a warning based on the detected attenuated optical signal.

16. The method of claim 15 wherein the generating comprises generating the warning in response to the detected attenuated optical signal exceeding a threshold amount.

17. The method of claim 15 further comprising transmitting the warning to a central monitoring location.

18. A method for monitoring a fence, the method comprising:
transmitting a plurality of optical signals through a first end of an optical fiber cable having a plurality of optical fibers positioned along the fence and in which at least one sensor is attached to a different portion of the fence for receiving a portion of a different one of the plurality of optical fibers to define a plurality of zones, said sensors operable to compress the optical fibers to bend the optical fiber and attenuate transmission of an optical signal through said optical fiber in response vibration of the fence;
detecting at least one attenuated optical signal at the other ends of the plurality of optical fibers; and
generating a warning based on the at least one detected attenuated optical signal.

19. The method of claim 18 wherein the at least one sensor attached to said different portions of the fence comprises a plurality sensors for receiving a portion of the different one of the plurality of optical fibers to define the plurality of zones.

20. The method of claim 18 wherein, the sensors comprising:
a plate for attaching the sensor to the fence; and
a striker movably attached to the plate and the striker comprising a weight, the sensor configured for receiving a different one of the plurality of optical fibers between the striker and the plate.

21. The method of claim 18 wherein the generating warning comprises determining the zone where the vibration occurred.

22. A security system for detecting intrusion, the security system comprising:
a support positionable on the ground having a length and width and comprising a plurality of apertures extending therethrough;
at least one optical fiber extending along said length and width of the support;
a monitoring unit positioned remotely from said support, said monitoring unit comprising:
a light source for transmitting an optical signal into an end of the at least one optical fiber;
a detector for detecting the optical signal from the other end of said plurality of optical fibers; and
a controller operably connected to said light source for controlling transmission of the optical signal and operably connected to said detector for detecting attenuation of the optical and generating a warning based on the detected attenuated optical signal.

23. The security system of claim 22 wherein the support comprise a plastic mesh.

24. The security system of claim 22 wherein the optical fiber comprises a zigzag pattern.

25. A method for monitoring an area for intrusion, the method comprising:
providing an optical fiber extending along a width and a length of a horizontally disposed planar support having a plurality of apertures extending therethrough;
positioning the optical fiber and the support on the ground;
transmitting an optical signal through a first end of the optical fiber;
compressing the optical fiber between a force and a portion of the support adjacent to the apertures to bend the optical fiber and attenuate transmission of the optical signal through the optical fiber;
detecting the attenuated optical signal at the other end of the optical fiber; and
generating a warning of intrusion of the area based on the detected attenuated optical signal.

26. The method of claim 25 wherein the support comprises a plastic mesh

27. The method of claim 25 further comprising applying the force by a person walking on the optical fiber and support.

28. The method of claim 25 wherein the positioning comprises positing the optical fiber and support below the surface of the ground, and further comprising covering the optical fiber and the support with a material that blends with the surrounding ground.

29. The method of claim 25 wherein the generating comprises generating the warning in response to the detected attenuated optical signal exceeding a threshold amount.

30. The method of claim 29 further comprising transmitting the warning to a central monitoring location.
